(19) United States
(12) Patent Application Publication
(10) Pub. No.: US 2011/0281003 A1
(43) Pub. Date: Nov. 17, 2011

(54) METHOD AND SYSTEM FOR DERIVING ANIMAL FEED FROM WASTE FOOD

(75) Inventor: IBRAHIM M. ALRUQAIE, Riyadh (SA)

(73) Assignee: KING ABDUL AZIZ CITY FOR SCIENCE AND TECHNOLOGY, Riyadh (SA)

(21) Appl. No.: 12/779,136

(22) Filed: May 13, 2010

(51) Int. Cl. A23K 1/00; A23K 1/24; E04H 7/22; A23K 1/16; A47J 44/00; A47J 43/04; A23P 1/12; A23K 1/18

(52) U.S. Cl. 426/311; 426/516; 426/418; 426/506; 99/494; 99/537; 454/173

(57) ABSTRACT

A method and system for deriving animal feed from waste food is provided. The method and system involves dehydrating the waste food. The dehydrated waste food is grinded and mixed with one or more nutrients based on requirements of an animal. Thereafter, a mixture of the waste food and the one or more nutrients is extruded to obtain a plurality of grain pellets with a predetermined consistency. The plurality of grain pellets obtained after extrusion are cut to obtain a required shape and size for a grain pellet. Thereafter, the plurality of grain pellets are conditioned by adding one or more of fat, minerals and vitamins to the plurality of grain pellets. The plurality of pellets thus obtained are packaged and supplied as animal feed.

### FIELD OF THE INVENTION

The invention generally relates to recycling of waste food. More specifically, the invention relates to recycling of waste food to derive animal feed.

### BACKGROUND OF THE INVENTION

In present scenario, waste food, such as leftover food from houses, restaurants, and bakeries is considered to be a low valued waste which may not result in economical products upon recycling. Therefore, generally, the waste food is utilized by decomposing the waste food to obtain biological products like manure and bio-gas. Such applications do not utilize nutritional value of the waste food. In order to utilize the nutritional value of the waste food, at times the waste food is as it is provided as an animal feed to animals. However, as it is utilization of the waste food might be unhygienic for the animals.

For the animals, such as fishes and poultry, processed animal feed is generally produced from corn and cereal flours. Such animal feeds involve a high raw material cost. Further, cost of manufacturing of the animal feeds is also high.

There is therefore need of effectively utilizing the waste food to obtain the animal feed. Further, there is a need of incorporating economical method and system for deriving the animal feed from the waste food.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a flow diagram for deriving animal feed from waste food in accordance with various embodiments of the invention.

FIG. 2 illustrates a flow diagram for performing extrusion on waste food in accordance with an embodiment of the invention.

FIG. 3 illustrates a block diagram of a system for deriving animal feed from waste food in accordance with an embodiment of the invention.

FIG. 4 illustrates a block diagram of an extruder for performing extrusion on waste food in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the present invention, it should be observed that the embodiments reside primarily in combinations of method steps and components related to production of animal feed from waste food. Accordingly, the components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Generally speaking, pursuant to various embodiments, the invention provides a method and system for deriving animal feed from waste food. The method and system of the invention involves dehydrating the waste food. The dehydrated waste food is then grinded and mixed with one or more nutrients based on requirements of an animal. Thereafter, a mixture of the waste food and the one or more nutrients is extruded to obtain a plurality of grain pellets with a predetermined consistency.

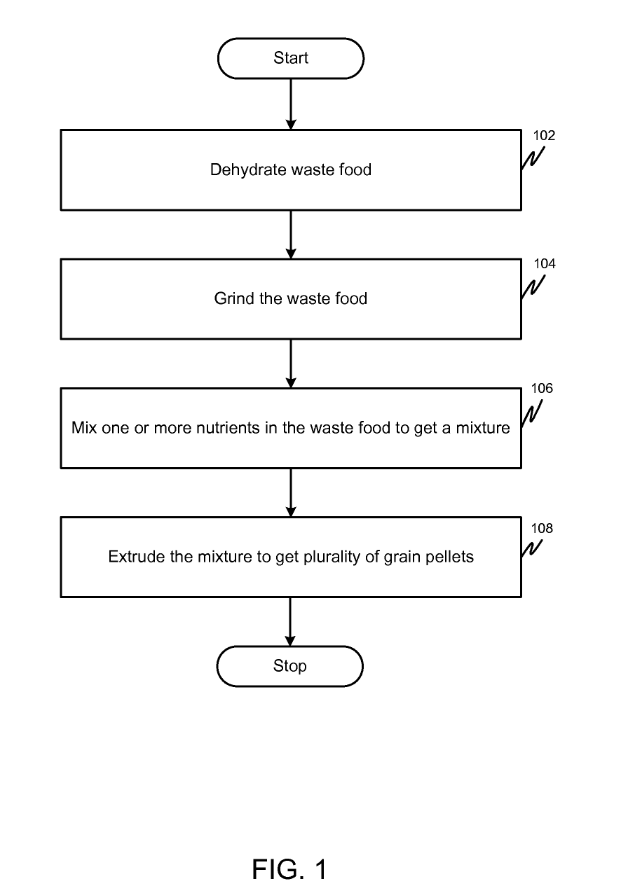

FIG. 1 illustrates a flow diagram for deriving animal feed from waste food in accordance with various embodiments of the invention. The waste food may be obtained from various sources, such as leftover food from homes, unused or leftover food from restaurants, leftover breads and cakes from bakeries and so forth. Such waste food generally includes a high quantity of cereals, vegetables and grains. Therefore, the waste food contains about 80% to 90% of carbohydrates. Further, this waste food is utilized for deriving animal feed for various types of animals. In an embodiment, the animal feed may be derived for fishes or poultry. In another embodiment, the animal feed may be derived for any other animal.

In order to derive the animal feed from the waste food, at step 102, the waste food is dehydrated to reduce moisture content of the waste food. The moisture content of the waste food is reduced to less than 10%. Reduction of the moisture content enables avoiding spoilage of the waste food. In order to reduce the moisture content, the dehydration may involve heating the waste food in presence of air flow to evaporate the moisture content of the waste food. In an embodiment, the heating of the waste food may be conducted at a temperature in range of 100° C. to 120° C. The temperature is set based on speed of the air flow and the moisture content in the waste food. Various known dehydrating methods and devices may be used for dehydrating the waste food, such as, tunneled hot air drying with a conveyer belt, drying in microwave tunnel, drying in a bin, drying in a tray, spray drying, and convection drying.

In an embodiment, the waste food is dehydrated by drying in a tray, in which the waste food is spread in the tray. Subsequently, heating is performed by sweeping a warm air current across the tray by conduction. The warm air current enables evaporation of the moisture content and thereby dehydrating the waste food.

In another embodiment, the waste food is dehydrated by drying in a bin, which involves utilizing a bin with a perforated bottom. The waste food is maintained in the bin and warm air is blown vertically upwards. As the warm air passes through the bin via the perforated bottom the waste food is dehydrated.

Upon dehydration, the dehydrated waste food is grinded at step 104. The waste food is grinded to obtain a powder from the waste food. In an embodiment grinding of the waste food may involve pressing the waste food between two surfaces with force. In an alternate embodiment, grinding of the waste food may involve grinding the waste food by utilizing a rotating blade. Alternately, grinding of the waste food may be performed by utilizing various known grinding devices, such as, but not limited to, a food processing device, a hammer crusher device, a hammer mill device, and a powder making device.

Thereafter, at step 106, one or more nutrients are added in the waste food which has been grinded. The one or more nutrients may be selected from protein, mineral, salt, and ion. Addition of the one or more nutrients involves chemically analyzing nutritional composition of the waste food. A ratio of various nutrients in the waste food is identified to find existing nutrition level of the waste food. For example, the waste food may include a high percentage of carbohydrates; however, percentage of proteins in the waste may be low. Therefore, based on the chemical analysis, a predetermined quantity of the one or more nutrients is mixed with the waste food to form a mixture. The predetermined quantity of the one or more nutrients in the mixture is based on a nutrition level required for an animal for which the animal feed is to be produced from the waste food. The predetermined quantity of the one or more nutrients further depends on different factors pertaining to the animal, such as breed of the animal, age of the animal, gender of the animal and so forth.

In an embodiment, the predetermined quantity of the one or more nutrients is based on a nutrition level required for the fishes. The nutrition level for the fishes generally includes a high percentage of proteins (about 35%-40%) and about 50%-80% of carbohydrates. Further, the nutrition level required for the fishes may also include small quantities of minerals, salts and ions. Based on the nutrition level for the fishes and the nutritional composition of the waste food, the predetermined quantity of the one or more nutrients required, is identified and is mixed with the waste food to form a mixture.

In another embodiment, the predetermined quantity of the one or more nutrients is based on a nutrition level required for poultry. The nutrition level for the poultry generally includes a high percentage of fats and carbohydrates. Further, the nutrition level includes a lower quantity of proteins, salts and ions. Therefore, based on the nutrition level for the poultry and the existing nutritional composition of the waste food, the predetermined quantity of the one or more nutrients required is identified and is mixed with the waste food to form a mixture.

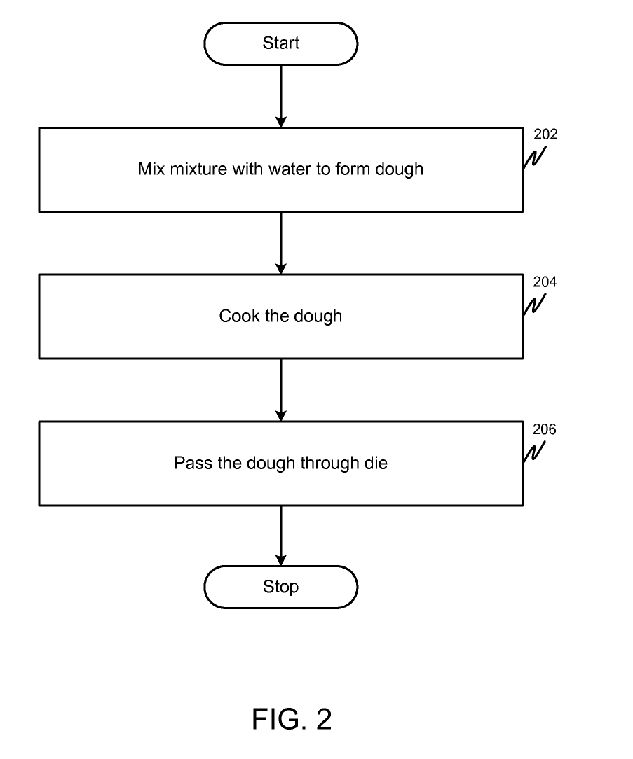

In an embodiment, once the mixture is prepared, the mixture is stored in a silo. From the silo the mixture is transferred for performing extrusion. Subsequently, extrusion is performed at step 108. Extrusion of the mixture is performed in an open environment to obtain a plurality of grain pellets from the mixture, with a predetermined consistency. The process of extrusion is explained in detail in conjunction with FIG. 2.

In an embodiment, the plurality of grain pellets obtained after extrusion are cut to obtain a required shape and size for a grain pellet. The required shape and size for a grain pellet is based on a type of an animal for which the animal feed is to be prepared. Further, the shape and size for a grain pellet may also depend on age and breed of the animal. In an embodiment of the invention, a cutter unit may be used for shaping the plurality of grain pellets. Based on speed of the cutter, size of the plurality of grain pellet may be controlled. For example, small size of the plurality of grain pellets may be obtained by maintaining a high speed of the cutter. Alternately, large size of the plurality of grain pellets may be obtained by maintaining slow speed of the cutter. In addition the shape and size of the plurality of grain pellets may also depend on rotational speed maintained while performing extrusion. A high rotational speed (RPM) while performing extrusion may result in large size of the plurality of grain pellets. Alternately, a slow rotational speed while performing extrusion may result in small size of the plurality of grain pellets.

Thereafter the plurality of grain pellets are conditioned by adding one or more of fat, minerals and vitamins to the plurality of grain pellets. One or more of fat, minerals and vitamins are added in the plurality of grain pellets after performing extrusion as nutrients, such as fat, minerals and vitamins get damaged due to heat.

Quantity of the fat and vitamins added to the plurality of grain pellets is based on type of an animal for which the animal feed is to be prepared. For example, a high quantity of fat is added to the plurality of grain pellets for animal feed for poultry. Whereas, a high quantity of vitamins are added to the plurality of grain pellets for animal feed for fishes. In an embodiment, a horizontal cylinder mixer is utilized for adding fat, minerals or vitamins to the plurality of grain pellets.

Upon conditioning, the plurality of grain pellets may again be dried to reduce the moisture content of the plurality of grains to less than 10%. Thereafter, the plurality of grains may be packaged and supplied as animal feed for respective animals.

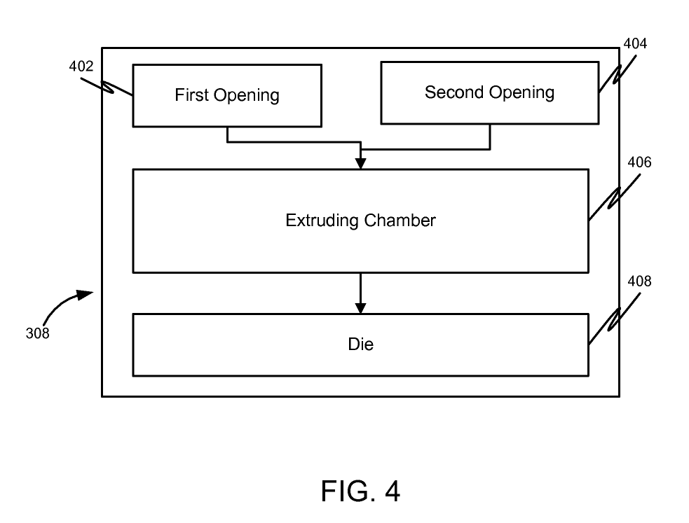

FIG. 2 illustrates a flow diagram for performing extrusion on the waste food in accordance with an embodiment of the invention. As discussed in detail in conjunction with FIG. 1, extrusion is performed on the mixture of the waste food and the one or more nutrients. The mixture is stored in a silo, prior to performing the extrusion. Subsequently, the mixture is transferred from the silo to a system for performing the extrusion. The system for performing the extrusion has been explained in detail in conjunction with FIG. 4.

The extrusion process involves mixing the mixture with water at step 202. A predetermined amount of water is mixed to prepare a dough from the mixture. Further, kneading is done on the dough to smoothen the dough. Thereafter, the dough is cooked in an open environment at step 204. Cooking of the dough is performed at a cooking temperature. In an embodiment, the cooking temperature varies from 120° C. to 170° C. Cooking temperature is maintained such that, nutrients in the dough containing the waste food and the one or more nutrients, are not destroyed. Further, by cooking the dough, any pathogen or germs in the waste food are removed and the waste food is made hygienic.

Thereafter, at step 206, the dough is passed through a die. A high pressure is exerted on the dough while passing through the die. Further, as the dough comes out of the die, due to a sudden pressure variation, the dough is expanded and the water from the pellets is evaporated. As a result, dried portions of the dough which are the plurality of grain pellets are obtained.

The extrusion process results in providing the plurality of grain pellets with a predetermined consistency. The predetermined consistency is based on the type of animal for which the animal feed is to be produced from the waste food.

In an embodiment, the predetermined consistency is puffed for fishes. Puffed consistency of the plurality of grain pellets is obtained by increasing the predetermined amount of water mixed with the mixture to obtain the dough. For example, the predetermined amount of water to be mixed with the mixture is increased to 15-20 ml water/min. Further, a higher cooking temperature may be maintained for extruding, such as cooking temperature between 150° C.-170° C. In addition, a rotational speed of the system performing the extrusion might be maintained at higher speed, such as 200-230 RPM. These changes result in the plurality of grain pellets with puffed consistency. The puffed consistency enables the plurality of grain pellets to float on water. For example, a required amount of puffed consistency of the plurality of grain pellets enables the plurality of grain pellets to float in water for about 72 hours.

In another embodiment, the predetermined consistency is solid for poultry. Thus, the plurality of grain pellets are processed to provide solid consistency in the plurality of grain pellets. Solid consistency may be obtained by lowering the predetermined quantity of water to be mixed with the mixture to obtain the dough. For example, the predetermined amount of water to be mixed with the mixture is lowered to 5-10 ml water/min. Further, a lower cooking temperature may be maintained for extruding, such as cooking temperature between 120° C. to 140° C. In addition, a rotational speed of the system performing the extrusion might be maintained low, such as 180-200 RPM. These changes result in the plurality of grain pellets with solid consistency. Due to the solid consistency, the plurality of grain pellets are easily consumable by the poultry.

The extrusion process provides high quality to the plurality of grain pellets, which are obtained from the waste food. Since the extrusion process involves heating the waste food, the nutrients in the waste food are conserved, while pathogen, pollutants or contaminations in the waste food are effectively destroyed.

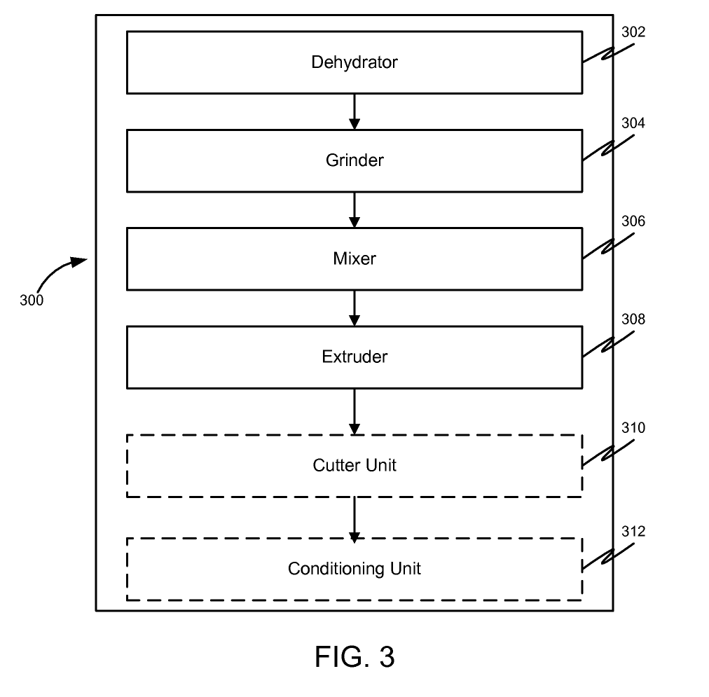

FIG. 3 illustrates a block diagram of a system 300 for deriving the animal feed from the waste food in accordance with an embodiment of the invention. System 300 includes a dehydrator 302 for dehydrating the waste food. Various known dehydrators may be used as dehydrator 302, such as, but not limited, dehydrators with vertical/horizontal air flow, solar dryer, convection dryer, tunnel hot-air drier, rotary dryer, microwave tunnel dryer, bin dryer, belt dryer, tray dryer, tunnel dryer, and so forth. Moisture content of the waste food is removed to less than 10% in dehydrator 302. A temperature in range of 100° C. to 120° C. may be maintained in dehydrator 302 for heating the waste food.

From dehydrator 302, the dehydrated waste food is transferred to a grinder 304. In response to receiving the dehydrated waste food, grinder 304 grinds the waste food to obtain a powder of the waste food. Various known grinding machines may be used as grinder 304, such as food processing grinder, hammer crusher grinder, hammer mill device, powder making grinder, belt grinder, bench grinder, cylindrical grinder, surface grinder, tool and cutter grinder, and jig grinder.

Upon grinding, the waste food is transferred to a mixer 306. Mixer 306 mixes one or more nutrients with the waste food to form a mixture. Mixer 306 mixes a predetermined quantity of the one or more nutrients in the waste food. The predetermined quantity of the one or more nutrients is derived by chemically analyzing nutritional composition of the waste food. Further, the predetermined quantity is based on a nutrition level required by a type of animal, for which the animal feed is to be produced from the waste food. Derivation of the predetermined quantity of the one or more waste food has been explained in detail in conjunction with FIG. 1.

In an embodiment, mixer 306 is a chamber in which the one or more nutrients are manually mixed with the waste food. Expert technicians, who are aware about the predetermined quantity of the one or more nutrients to be mixed with the waste food, are involved in the manual mixing, in such a scenario. In another embodiment, mixer 306 is a chamber which is equipped with automatic tools for mixing the predetermined quantity of the one or more nutrients with the waste food.

Once the mixture is prepared, the mixture may be stored in silo before any further processing is done. Subsequently, the mixture is transferred to an extruder 308 from the silo. Extruder 308 extrudes the mixture in an open environment to obtain plurality of grain pellets with a predetermined consistency. Functionality of extruder 308 is explained in detail in conjunction with FIG. 4.

In an embodiment, after obtaining the plurality of grain pellets from extruder 308, the plurality of grain pellets are cut using a cutter unit 310 to obtain a required shape and size for a grain pellet. The required shape and size for a grain pellet is based on a type of an animal for which the animal feed is to be prepared. Further, the shape and size for a grain pellet may also depend on age and breed of the animal.

Thereafter the plurality of grain pellets are conditioned by a conditioning unit 312. Conditioning unit 312 adds one or more of fat, minerals and vitamins to the plurality of grain pellets. One or more of fat, minerals and vitamins are added in the plurality of grain pellets after performing extrusion as nutrients, such as fat, minerals and vitamins get damaged due to heat.

Quantity of the fat and vitamins added to the plurality of grain pellets is based on type of an animal for which the animal feed is to be prepared. For example, a high quantity of fat is added to the plurality of grain pellets for animal feed for poultry. Whereas, a high quantity of vitamins are added to the plurality of grain pellets for animal feed for fishes. In an embodiment, fat, minerals or vitamins are absorbed in the plurality of grain pellets by utilizing a horizontal cylinder mixer of conditioning unit 312.

Upon conditioning in conditioning unit 312, the plurality of grain pellets may be dried to reduce moisture of the plurality of grain pellets to less than 10%. Thereafter the plurality of grain pellets may be packaged and supplied as the animal feed for respective animals.

FIG. 4 illustrates a block diagram of extruder 308 for performing extrusion on the waste food in accordance with an embodiment of the invention. Examples of extruder 308 may include, but are not limited to, single screw extruder, twin screw extruder, and cooking extruder. As discussed in detail in conjunction with FIG. 3, extruder 308 receives a mixture of the waste food and one more nutrients and performs extrusion on the mixture.

Extruder 308 includes a first opening 402 for receiving the mixture. First opening 402 may be mounted on top of extruder 308. Further, first opening 402 may be conical in shape. In an embodiment, first opening 402 is connected with a silo in which the mixture is stored.

Apart from first opening 402, extruder 308 also includes a second opening 404. Second opening 404 receives water from an external water source. An automated pump may be utilized for providing a predetermined amount of water to second opening 404.

First opening 402 and second opening 404 are connected with an extruding chamber 406. First opening 402 transfers the mixture into extruding chamber 406. Further, second opening 404 transfers the water into extruding chamber 406. In extruding chamber 406, the mixture is mixed with the water to prepare a dough. Once the dough is prepared, kneading is done on the dough to smoothen the dough.

Upon kneading, the dough is cooked in extruding chamber 406. Extruding chamber 406 cooks the dough at a cooking temperature, wherein the cooking temperature may vary from 120° C. to 170° C. In an embodiment, an optimum pressure is also maintained in extruding chamber 406 to cook the dough.

In an embodiment, extruding chamber 406 may be a barrel. The barrel includes one or more zones through which the mixture of the waste food is moved and treated. A first zone involves mixing of the mixture with water to obtain the dough. Similarly, a second zone is maintained for kneading the dough. Also, a third zone is maintained for cooking the dough. Finally a fourth zone utilized for maintaining the dough in a high pressure. The one or more zones are maintained at varying temperature and pressure. For example, temperatures in the first, second, third, and fourth zone may be maintained as 90° C., 120° C., 140° C., and 160° C. respectively. The barrel also includes one or more screws for facilitating functionalities of the zones of the barrel. The one or more screws extend longitudinally along the length of the barrel and include different segments in different zones. For example, a first segment of the one or more screw enables moving of the mixture, a second segment enables mixing of the mixture with the water, a third segment enables kneading of the dough, and lastly a fourth segment enables pushing of the dough through a die opening.

After cooking, the dough is transferred from extruding chamber 406 to a die 408. Die 408 presses the dough to obtain a plurality of grain pellets. Die 408 may be placed at an end of extrusion chamber 406. For example, die 408 may be placed at an end of the fourth zone of the barrel. As the dough passes through die 408, a high pressure is exerted on the dough. Further, as the dough comes out of die 408, due to a sudden pressure variation between opening of the die inside extruding chamber 406 and opening of die outside extruding chamber 406, the dough is expanded and the water from the dough is evaporated. As a result, the plurality of grain pellets are obtained from the dough.

After obtaining the plurality of grain pellets from extruder 308, the plurality of grain pellets are cut using cutter unit 310 to obtain a required shape and size for a grain pellet. The plurality of grain pellets obtained from cutter unit 310 of extruder 308 have a predetermined consistency. The predetermined consistency in the plurality of grain pellets is based on the type of animal for which the animal feed is to be produced from the waste food. Based on variation of the predetermined amount of water, the cooking temperature, and a rotational speed of extruder 308, a required predetermined consistency is imparted to the plurality of grains. For example, a puffed consistency is imparted to the plurality of grains, when the predetermined amount of water, the cooking temperature, and the rotational speed of extruder 308 are maintained high. Such plurality of grains with puffed consistency are utilized for fishes. Similarly, a solid consistency is imparted to the plurality of grain pellets when the predetermined amount of water, the cooking temperature, and the rotational speed of extruder 308 are maintained low. Such plurality of grains with solid consistency, are utilized for poultry.

The plurality of grain pellets obtained from extruder 308 may be conditioned and then packaged and supplied as the animal feed.

Various embodiments of the invention provide method and system for deriving animal feed from waste food. The method and system enables utilizing of the waste food which has been leftover and discarded in restaurants, bakeries or homes. Such waste food is easily available and also raw material cost involved in the animal feed produced from the waste food is negligible. In addition, as the waste food is processed by performing extrusion at a cooking temperature, the nutrients in the waste food are conserved, while pathogen, pollutants or contaminations in the waste food are effectively destroyed. Further, the extrusion process enables providing high quality to the animal feed. Moreover, processing consistency of the grain pellets obtained from the waste food ensures that the animal feed is easily digested by the animals, such as fishes or poultry. Therefore, an efficient and economical method and system is provided for deriving the animal feed from the waste food.

Those skilled in the art will realize that the above recognized advantages and other advantages described herein are merely exemplary and are not meant to be a complete rendering of all of the advantages of the various embodiments of the present invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. A method for deriving animal feed from waste food, the method comprising:
dehydrating the waste food, wherein the waste food is dehydrated to reduce moisture content of the waste food to less than 10%;
grinding the waste food, wherein the waste food is dehydrated;
mixing at least one nutrient in the waste food in response to grinding, wherein a predetermined quantity of the at least one nutrient is mixed in the waste food to obtain a mixture; and
extruding the mixture to obtain a plurality of grain pellets with a predetermined consistency.

2. The method of claim 1 further comprises cutting the plurality of grain pellets for shaping the plurality of grain pellets.

3. The method of claim 1 further comprises conditioning the plurality of grain pellets, wherein conditioning comprise adding at least one or more of a fat, a mineral, and a vitamin to the plurality of grain pellets.

4. The method of claim 1, wherein the waste food is obtained from leftover food materials.

5. The method of claim 4, wherein the waste food comprises carbohydrates in range of 80% to 90%.

6. The method of claim 1, wherein the animal feed is derived for poultry.

7. The method of claim 1, wherein the animal feed is derived for fishes.

8. The method of claim 1, wherein the waste food is grinded to obtain a powder.

9. The method of claim 1, wherein the at least one nutrient is at least one of protein, mineral, salt, and ion.

10. The method of claim 1, wherein the predetermined quantity of the at least one nutrient is based on a nutrition level required for poultry.

11. The method of claim 1, wherein the predetermined quantity of the at least one nutrient is based on a nutrition level required for fishes.

12. The method of claim 1, wherein mixing the at least one nutrient in the waste food further comprises storing the mixture in a silo.

13. The method of claim 1, wherein the predetermined consistency is solid.

14. The method of claim 1, wherein the predetermined consistency is puffed.

15. The method of claim 1, wherein extruding the mixture comprises:
mixing the mixture with a predetermined amount of water to obtain a dough;
cooking the dough at a cooking temperature; and
passing the dough through a die in response to cooking to obtain the plurality of grain pellets.

16. The method of claim 15, wherein the predetermined amount of water is based on the predetermined consistency.

17. The method of claim 15, wherein the cooking temperature is based on the predetermined consistency.

18. The method of claim 15, wherein the cooking temperature is in a range of 120° C. to 170° C.

19. The method of claim 15, wherein passing the dough through the die comprises evaporating water from the dough.

20. A system for deriving animal feed from waste food, the system comprising:
a dehydrator for dehydrating the waste food, wherein the waste food is dehydrated to reduce moisture content of the waste food to less than 10%;
a grinder for grinding the waste food, wherein the waste food is dehydrated;
a mixer for mixing at least one nutrient in the waste food in response to grinding, wherein a predetermined quantity of the at least one nutrient is mixed in the waste food to obtain a mixture; and
an extruder for extruding the mixture to obtain a plurality of grain pellets with a predetermined consistency.

21. The system of claim 20 further comprises a cutter unit for shaping the plurality of grain pellets

22. The system of claim 20 further comprises a conditioning unit, the conditioning unit comprises:
a horizontal cylinder mixer for mixing at least one of a fat, a mineral and a vitamin with the plurality of grain pellets.

23. The system of claim 20, wherein the extruder further comprises a silo for storing the mixture prior to extruding the mixture.

24. The system of claim 20, wherein the extruder further comprises:
an extruding chamber for extruding the mixture at a cooking temperature;
a first opening for transferring the mixture into the extruding chamber; and
a second opening for transferring water into the extruding chamber.

25. The system of claim 24, wherein the first opening and the second opening are mounted on top of the extruding chamber.

26. The system of claim 20, wherein the extruder further comprises a die for obtaining the plurality of grain pellets from the mixture.
